(19) United States
(12) Patent Application Publication
(10) Pub. No.: US 2005/0003090 A1
(43) Pub. Date: Jan. 6, 2005

(54) Method of forming pattern of transparent conductive film

(76) Inventor: Takuya Miyakawa, Okaya City (JP)

Correspondence Address: HARNESS, DICKEY & PIERCE, P.L.C., P.O. BOX 828, BLOOMFIELD HILLS, MI, 48303, US

(21) Appl. No.: 10/843,700

(22) Filed: May 11, 2004

(30) Foreign Application Priority Data
May 12, 2003 (JP) 2003-132734

(51) Int. Cl. B05D 3/02

(52) U.S. Cl. 427/256; 427/443.1; 427/372.2

(57) ABSTRACT

A method is provided for forming a pattern of a transparent conductive film. The method includes a sensitizing step for coating a surface of a substrate with a solution where a platinum group element is dispersed in accordance with a given pattern, an annealing step for fixing the platinum group element on the surface of the substrate, a film forming step for depositing a tin conductive film on the portion for which the sensitizing is implemented by immersing the substrate in a tin plating bath for a given time, and an oxidizing step for oxidizing the tin conductive film to form a transparent conductive film.

### RELATED APPLICATIONS

This application claims priority to Japanese Patent Application No. 2003-132734 filed May 12, 2003 which is herby expressly incorporated by reference herein in its entirety.

### BACKGROUND

1. Field of the Invention

The present invention relates to a method of forming a pattern of a transparent conductive film, and particularly relates to a method of forming a pattern of a transparent conductive film that is suitable for forming a shielding film for leaked electromagnetic waves used for a liquid crystal display and the like, and a transparent electrode used for a various kinds of electronic devices and the like.

2. Description of the Related Art

Conventionally, a transparent electrode has been used for a shielding film for leaked electromagnetic waves in a liquid crystal display, an electroluminescence display and so on, and a transparent electrode in electronic devices of various kinds and the like.

An example of such a method for forming a transparent electrode is described in Japanese Unexamined Patent Application Publication No. 5-151840. According to the transparent electrode forming method described in Japanese Unexamined Patent Application Publication No. 5-151840, a transparent electrode including any one of tin oxide and zinc oxide is formed on a transparent substrate by means of evaporation, sputtering and such.

Since the transparent electrode formed according to the above mentioned method has low electrical conductivity, it is necessary to provide an auxiliary electrode formed of metal of low electrical resistance. In order to form the auxiliary electrode, first, the surface of the transparent electrode is covered with photo-resist, and a given part of the photo-resist is removed, and then the transparent electrode is etched into a given shape. After the etching, the whole transparent substrate is plated by immersing the transparent substrate in a non-electrolysis plating bath. The photo-resist is removed after plating, and thereby the transparent electrode including the auxiliary electrode of low resistance metal is formed on a given portion.

The above described transparent electrode, however, has low electrical conductivity and low transmittance. In addition, as for a method for forming the auxiliary electrode, which is provided to compensate for the low electrical conductivity, there are many manufacturing steps and also wasted plating materials such that the productivity is low.

The present invention is intended to provide a method of forming a pattern of a transparent conductive film, in which it is easy to form a pattern of a transparent electrode with high electrical conductivity and high optical transparency.

### SUMMARY

In order to achieve the above mentioned aim, a method of forming a pattern of a transparent conductive film according to one aspect of the present invention comprises a catalyst layer forming step for forming a given sensitive pattern including a platinum group element on a surface of a substrate, a film forming step for depositing any one of zinc oxide and tin oxide on a surface of the sensitive pattern by non-electrolysis plating, by immersing the substrate in a plating bath and an annealing step for heating the one of zinc oxide and tin oxide deposited on the surface of the sensitive pattern to form a transparent conductive film.

According to the method of the present invention, the oxide of zinc or tin is deposited on a catalyst layer including a platinum group element, and then the oxide is annealed to achieve a transparent conductive film. Thus, it is possible to form a pattern of a transparent conductive film with high transparency without reducing electrical conductivity.

A method of forming a pattern of a transparent conductive film according to another aspect of the present invention comprises a catalyst layer forming step for forming a given sensitive pattern including a platinum group element on a surface of a substrate, a film forming step for depositing any one of zinc and tin on the surface of the sensitive pattern by non-electrolysis plating, by immersing the substrate in a plating bath and an annealing step for heating the any one of zinc and tin deposited on the surface of the sensitive pattern in the oxidizing atmosphere to oxidize the one of zinc and tin so as to form a transparent conductive film.

According to this method, it is also possible to provide almost the same advantageous effect as that of the previously described method.

In the method, the catalyst layer forming step may include a coating step for coating the surface of the substrate with a solution where the platinum group element is dispersed, in accordance with a given pattern and a heating step for fixing the solution on the surface of the substrate by heating,

Thereby, it is possible to prevent the platinum group element from dispersing in the plating bath again in a film forming step.

In the method, the catalyst layer forming step of the present invention may comprise a liquid-repellent film forming step for forming a liquid-repellent film on the surface of the substrate, a lyophilic portion providing step for forming a lyophilic portion by removing the liquid-repellent film in accordance with a given pattern, a coating step for coating the lyophilic portion with a solution where the platinum group element is dispersed and a drying step for drying the solution so as to solidify the solution.

According to this method, it is not necessary to include a heating step after coating the solution where the platinum group element is dispersed.

It is also possible to apply the solution where the platinum group element is dispersed by ink-jetting and so on. According to this method, a given pattern can be easily formed.

It is preferable that the platinum group element be palladium. Palladium is extremely stable in the air and water among platinum group elements, and has good corrosion resistance. It is cheaper than platinum and rhodium, which are considered to be preferable for a plating material as well as palladium. As a result, the production cost can be reduced.

### BRIEF DESCRIPTION OF THE DRAWINGS

FIG. 1 is a diagram showing a film forming device to form a liquid-repellent film according to a third embodiment of the present invention.

### DETAILED DESCRIPTION

Embodiments according to the present invention will be explained below.

A first embodiment of the invention is characterized in that a transparent conductive film is formed by the following steps; coating a surface of a substrate with a solution where palladium is dispersed, that is, a platinum group element (referred to as palladium-dispersed liquid hereinafter), drying the solution, immersing the substrate in a tin plating bath to deposit the tin plating on the surface of the substrate coated with the solution, and then oxidizing the tin.

More particularly, a solution is used as the solution with dispersed palladium whose concentration is adjusted by adding water or alcohol into a solution prepared by dispersing chloride palladium into concentrated hydrochloric acid. Preferred raw materials for the substrate are those with high corrosion resistance against catalyst and chemicals within a plating bath, and with optical transparency. For example, glass, a board-shaped material, or a film material that are composed of transparent resin can be used.

First, the surface of the substrate is cleaned and degreased by alcohol and such. After cleaning and degreasing, it is better to improve the absorptivity of plating by etching the surface of the substrate with concentrated sulfuric acid and so on to make the surface of the substrate rough, if necessary.

The sensitizing treatment (activating) for the surface of the substrate is implemented by applying the palladium-dispersed liquid onto it. On this occasion, it is better to form a given pattern on the surface of the substrate.

After applying the palladium-dispersed liquid on the surface of the substrate, the palladium-dispersed liquid is dried. Then, after drying the palladium-dispersed liquid, the surface of the substrate is heated (annealing treatment) so that palladium may be oxidized to be fixed on the surface of the substrate. Thereby, it is possible to prevent palladium from dispersing into the plating bath, even if the substrate is immersed in the plating bath, as described later. Instead of the annealing treatment, it is also possible to fix palladium on the surface of the substrate by applying the palladium-dispersed liquid after coating the surface of the substrate with tin (2) ions. According to this method also, a stable plating treatment can be realized (refer to chemical formula 1).
SnCl₂+PdCl₂→SnCl₄+Pd (catalyst nucleus) chemical formula 1

With the reduction reaction of the chloride palladium advancing, palladium is adsorbed to the surface of the substrate, and thereby the sensitizing treatment (sensitizing+activating) is implemented.

After palladium is fixed on the surface of the substrate, the substrate is immersed in the tin plating bath so that the tin plating is deposited into a given pattern to form a film.

The tin plating bath may be prepared from sulfuric tin, P-phenol sulfurous acid, thiourea, hypo-phosphoric acid sodium, hydrochloric acid, N-dodecyl-N, N-dimethyl-N-carboxymethylbetaine, and catechol. The composition of the plating bath is shown as follows, for example.

| | |
|---|---|
| Sulfuric tin | 30 g/1 |
| p-phenol sulfurous acid | 120 g/1 |
| thiourea | 150 g/1 |
| hypo phosphoric acid sodium | 60 g/1 |
| hydrochloric acid | 0.2 mol/1 |
| N-dodecyl-N, N-dimethyl | 5 g/1 |
| -N-carboxymethylbetaine | |
| catechol | 0.5 g/1 |

According to the plating bath described above, the thickness of the plating layer deposited on the surface of the substrate varies depending on the temperature and so on. It is preferable to adjust the concentration by alcohol, water and such so that the tin plating layer with its thickness being about 2000 Å can be deposited on the portion coated with the palladium-dispersed liquid, by immersing the substrate in the plating bath for about 30 minutes.

The surface of the deposited tin plating layer is oxidized by anneal treatment, in other words, by ultra-violet rays (UV) exposure, plasma exposure and flash (light) exposure and so on in oxidizing atmosphere, or atmosphere to form a transparent conductive film. In the case of UV exposure, about 1500 Å tin plating layer is turned transparent by being exposed with 72 nm UV for 15 minutes. In the case of plasma exposure, exposure can be implemented with pressure of 0.1 Torr and oxygen concentration of 200 ppm. In the case of flash annealing, it is preferable to expose the substrate with about 5 shots exposure of its efficient heating temperature being about 500 to 600 degrees centigrade.

Next, a second embodiment according to the present invention will be explained.

Although the plating bath used in the second embodiment is different from that of the first embodiment, the steps before immersing the substrate in the plating bath are the same, and the explanation of these steps therefore are omitted.

Similar to the first embodiment, a film is formed by immersing the substrate with palladium fixed on its surface in the zinc plating bath including nitric acid zinc and dimethyl aminborane.

For example, the preferred composition of the plating bath is shown as follows.

| | |
|---|---|
| nitric acid | 0.1 mol/1 |
| dimethylaminborane | 0.03 mol/1 |

The plating layer of zinc oxide is deposited on the portion coated with the palladium-dispersed liquid by immersing the substrate in the plating bath of the above mentioned composition, as shown by the chemical formula 2.
Zn(NO₃)_{2→}Zn²⁺+2NO₃⁻
(CH₃)₂NHBH₃+H₂O_{→}BO₂⁻+(CH₃)₂NH+7H⁺+6e⁻
NO₃⁻+H₂O+2e_{→}NO₂⁻+2OH⁻
Zn²⁺+2OH⁻_{→}Zn(OH)₂
Zn(OH)_{2→}ZnO+H₂O chemical formula 2

The zinc plating bath is influenced by temperature and so on. In the same way as the first embodiment, it is preferable to adjust the concentration with alcohol, water and such so that the tin plating layer can be deposited with its thickness being about 2000 Å in 30 minutes.

According to the second embodiment, since the deposited plating layer is zinc oxide, the deposited conductive film already has optical transparency. It therefore is possible to provide a patterned transparent conductive film without an oxidizing step. If the plating layer of the zinc oxide is heated, however, the conductive film with higher transparency can be provided.

Next, a third embodiment will be explained.

The third embodiment is intended to add a previous step to the step for applying the palladium-dispersed liquid in accordance with an optional pattern, referred to in the first and second embodiments.

In this embodiment, first, a surface of a substrate is covered by a liquid-repellent film. The liquid-repellent film is not particularly limited, and fluorine film and silicone film can be used for example.

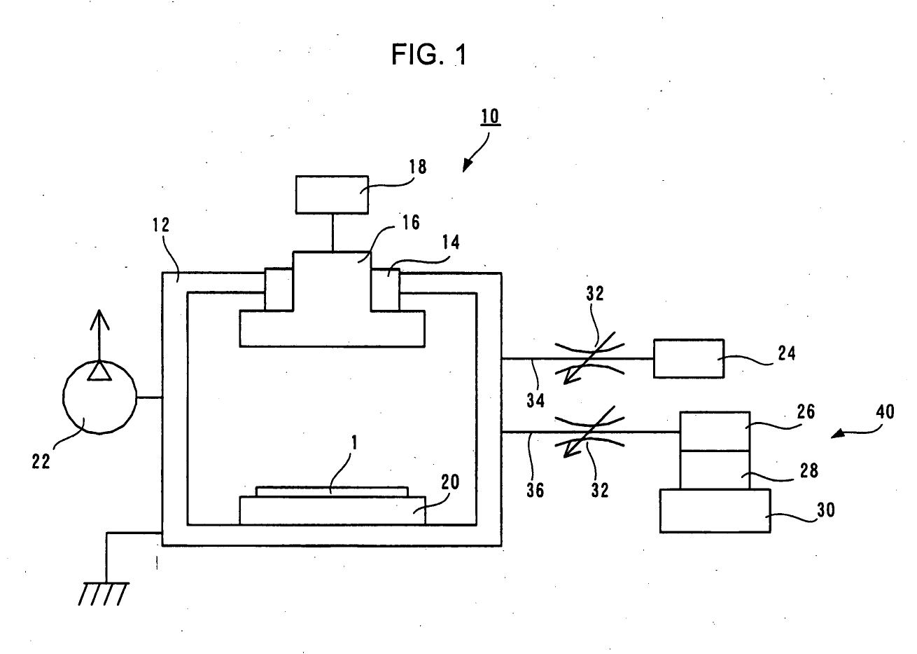

By way of example, the liquid-repellent film is formed by plasma polymerization via a film forming device, as shown in FIG. 1. A film forming device 10 comprises a vacuum pump chamber 12 including a vacuum pump 22, as its principal part. Inside the vacuum pump chamber 12, a treatment stage 20 where a substrate is mounted is provided on the lower surface of the vacuum pump chamber 12. The treatment stage 20 is preferably provided so that the temperature can be adjusted. A high frequency electrode 16 is provided on the surface of the vacuum pump chamber 12 via an insulator 14. The high frequency electrode 16 is connected to a high frequency power supply 18.

A raw material gas supply means 40 to supply a raw material for film forming, and an argon gas supply means 24 to supply argon gas and such for accelerating the film forming are connected to the vacuum pump chamber 12. The raw material gas supply means 40 includes a container 26 to contain a raw material 28 and a heater 30 to heat the container 26 and is connected to the vacuum pump chamber 12 via a raw material supply channel 36 with a flow control valve 32 The argon gas supply means 24 is also connected to the vacuum pump chamber 12 via an argon gas supply channel 34 with the flow control valve 32.

According to the film forming process by the film forming device 10 as shown in FIG. 1, first, a substrate 1 is disposed on the treatment stage 20. If the temperature of the treatment stage 20 is adjustable, it is preferable to keep the temperature of the substrate 1 low to promote the polymerization reaction of silicone resin. Next, the inside of the vacuum pump chamber 12 is evacuated to accelerate the polymerization reaction of silicone resin and prevent the other reaction than the polymerization reaction. The pressure is set to about 0.2 Torr by the evacuation, for example.

A film is formed by the plasma polymerization reaction in the above described environment. In the case of silicone resin film forming, hexamethyldisiloxane and such, which is liquid in the normal temperature, can be used for the raw material 28. The raw material 28 is heated by the heater 30 to be gasified and introduced to the vacuum pump chamber 12 of the negative pressure. In the case of introducing the gasified raw material to the vacuum pump chamber 12, a heater (not shown in FIG. 1) can be provided to the raw material supply channel 36 so that the gasified raw material may be heated once more and introduced to the vacuum pump chamber 12. At the same time, argon gas is also introduced to the vacuum pump chamber 12.

After that, high frequency voltage is applied to the inside of the vacuum pump chamber 12 by the high frequency electrode 16, allowing hexamethyidisiloxane to be ionized to be converted into plasma, and then polymerized on the surface of the substrate 1. According to the above described steps, a silicone resin polymerization film is formed with liquid-repellency. Thus, it is possible to form a liquid-repellent film even in a minute-shaped portion by plasma polymerization.

After covering the surface of the substrate with the liquid-repellent film, as described above, the liquid-repellent film is removed in accordance with an optional pattern shape. It is removed by ultra violet ray exposure and plasma exposure to a given portion. Of course, the liquid-repellent film may be mechanically removed.

Then, the palladium-dispersed liquid is applied on the removed portion of the liquid-repellent film, according to the above mentioned method. In the step for applying the palladium-dispersed liquid, according to the embodiment of this invention, it is possible to apply the palladium-dispersed liquid in accordance with a given pattern by simply immersing the substrate directly in the palladium-dispersed liquid. In the case of applying the palladium-dispersed liquid by immersing the substrate, if the film thickness of the palladium-dispersed liquid is thick, it is possible to apply the palladium-dispersed liquid on a given portion more effectively by de-aerating the coated portion.

According to the embodiment, the surface of the substrate does not need heating, after drying the palladium-dispersed liquid. Because there is little possibility that the palladium is to be dispersed again, due to the fact that a portion other than those coated with the palladium has the liquid-repellency against the plating bath, so, only the portion coated with the palladium makes contact with the plating bath and the plating layer is deposited thereon.

According to the first embodiment, the tin plating layer, and according to the second embodiment, the zinc oxide plating layer is disposed on the catalyst layer. Instead of this, the zinc plating layer in the first embodiment, and the tin oxide in the second embodiment can be alternatively deposited on the surface of the substrate.

In the coating step for applying the palladium-dispersed liquid, the dispersed liquid can be applied in accordance with a given pattern by ink-jetting, for example. In this way, it becomes easier to apply the dispersed liquid, the productivity therefore is improved. If the coating is implemented by ink-jetting, it is preferable that the viscosity of the dispersed liquid is sufficiently low.

According to the embodiment, a light transmitting raw material is used for the substrate. In fact, a light transmitting raw material is preferred for forming a pattern of a transparent conductive film. However, even if a general metal or a ceramic is used, there is no problem to form a pattern of a transparent conductive film. Furthermore, according to the embodiment, though the treatment for making the surface of the substrate sensitive is described as one step, the adsorption of plating layer can be improved by repeating the above described step a few times.

The method of forming a pattern of a transparent conductive film of this invention, as described above, comprises a catalyst layer forming step for forming a given sensitive pattern including a platinum group element on a surface of a substrate, a film forming step for depositing any one of zinc oxide and tin oxide on a surface of the sensitive pattern by non-electrolysis plating, by immersing the substrate in a plating bath and an annealing step for heating the one of zinc oxide and tin oxide deposited on the surface of the sensitive pattern to form a transparent conductive film. In this case, first, oxide of zinc or tin is deposited on a catalyst layer including palladium, that is, the platinum group element, and then annealing treatment is implemented to provide a transparent conductive film. As a result, it is possible to form a pattern of a transparent conductive film without reducing electrical conductivity.

According to another embodiment of this invention, which comprises a catalyst layer forming step for forming a given sensitive pattern including a platinum group element on a surface of a substrate, a film forming step for depositing any one of zinc and tin on a surface of the sensitive pattern by non-electrolysis plating, by immersing the substrate in a plating bath and an annealing step for heating the any one of zinc and tin deposited on the surface of the sensitive pattern in the oxidizing atmosphere to oxidize the one of zinc and tin so as to form a transparent conductive film, almost the same advantageous effect as described above can be expected.

According to the embodiment described above, the catalyst layer forming step includes a coating step for coating the surface of the substrate with a solution where the platinum group element is dispersed, and a heating step for fixing the solution on the surface of the substrate by heating, thereby, the platinum group element can be prevented from dispersing again in the plating bath in the step for forming a film.

According to the above described method, the catalyst layer forming step includes a liquid-repellent film forming step for forming a liquid-repellent film on the surface of the substrate, a lyophilic portion providing step for providing a lyophilic portion by removing the liquid-repellent film in accordance with a given pattern, a coating step for coating the lyophilic portion with a solution where the platinum group element is dispersed; and a drying step for drying the solution so as to solidify the solution. Thereby, the annealing treatment can be omitted after applying the solution having dispersed palladium.

If the solution where palladium is dispersed is applied by ink-jetting, a given pattern can be easily formed on the substrate.

In the case of using palladium as the platinum group element, the following advantageous effect can be expected.

Palladium is extremely stable in the air and in the water among platinum group elements, and also has good corrosion resistibility. Moreover, it is cheaper than platinum and rhodium and so on, which are considered to be good for a plating material as well as palladium. So, the reduction of the production cost can be realized. In the embodiment described above, although palladium is used as the platinum group element, platinum, rhodium, iridium, osmium and ruthenium and so on can be also used.

In the embodiment of this invention, the composition of each plating bath is concretely described above. However, this invention is not limited to the plating bath described above. Any plating bath can be used, as far as it can provide a plating layer of tin oxide or zinc oxide by non-electrolysis plating.

1. A method of forming a pattern of a transparent conductive film, comprising:
a catalyst layer forming step for forming a given sensitive pattern including a platinum group element on a surface of a substrate;
a film forming step for depositing any one of zinc oxide and tin oxide on a surface of the sensitive pattern by non-electrolysis plating, by immersing the substrate in a plating bath; and
an annealing step for heating the one of zinc oxide and tin oxide deposited on the surface of the sensitive pattern to make a transparent conductive film.

2. A method of forming a pattern of a transparent conductive film, comprising:
a catalyst layer forming step for forming a given sensitive pattern including a platinum group element on a surface of a substrate;
a film forming step for depositing any one of zinc and tin on a surface of the sensitive pattern by non-electrolysis plating, by immersing the substrate in a plating bath; and
an annealing step for heating the one of zinc and tin deposited on the surface of the sensitive pattern in an oxidizing atmosphere to oxidize the one of zinc and tin so as to make a transparent conductive film.

3. The method of forming a pattern of a transparent conductive film according to claim 1, wherein the catalyst layer forming step comprises:
a coating step for coating the surface of the substrate with a solution where the platinum group element is dispersed, in accordance with a given pattern; and
a heating step for fixing the solution on the surface of the substrate, by heating.

4. The method of forming a pattern of a transparent conductive film according to claim 1, wherein the catalyst layer forming step comprises:
a liquid-repellent film forming step for forming a liquid-repellent film on the surface of the substrate;
a lyophilic portion providing step for providing a lyophilic portion by removing the liquid-repellent film in accordance with a given pattern;
a coating step for coating the lyophilic portion with a solution where the platinum group element is dispersed; and
a drying step for drying the solution so as to solidify the solution.

5. The method of forming a pattern of a transparent conductive film according to claim 1, wherein the solution where the platinum group element is dispersed is coated by ink-jetting.

6. The method of forming a pattern of a transparent conductive film according to claim 1, wherein the platinum group element is palladium.

7. The method of forming a pattern of a transparent conductive film according to claim 2, wherein the catalyst layer forming step comprises:
a coating step for coating the surface of the substrate with a solution where the platinum group element is dispersed, in accordance with a given pattern; and
a heating step for fixing the solution on the surface of the substrate by heating.

8. The method of forming a pattern of a transparent conductive film according to claim 2, wherein the catalyst layer forming step comprises:
a liquid-repellent film forming step for forming a liquid-repellent film on the surface of the substrate;
a lyophilic portion providing step for providing a lyophilic portion by removing the liquid-repellent film in accordance with a given pattern;
a coating step for coating the lyophilic portion with a solution where the platinum group element is dispersed; and
a drying step for drying the solution so as to solidify the solution.

9. The method of forming a pattern of a transparent conductive film according to claim 2, wherein the solution where the platinum group element is dispersed is coated by ink-jetting.

10. The method of forming a pattern of a transparent conductive film according to claim 2, wherein the platinum group element is palladium.
